(19) United States
(12) Patent Application Publication
(10) Pub. No.: US 2019/0264082 A1
(43) Pub. Date: Aug. 29, 2019

(54) STRUCTURED ABRASIVE ARTICLE INCLUDING FEATURES WITH IMPROVED STRUCTURAL INTEGRITY

(71) Applicant: 3M INNOVATIVE PROPERTIES COMPANY, St Paul, MN (US)

(72) Inventors: Negus B. Adefris, St. Paul, MN (US); Scott R. Culler, Burnsville, MN (US); Meinolf Stenns, Hilden (DE); Juan A. Munoz, Blaine, MN (US); Nicholas D. Richardson, Mahtomedi, MN (US)

(21) Appl. No.: 16/349,642

(22) PCT Filed: Nov. 9, 2017
(86) PCT No.: PCT/US2017/060774

§ 371 Date: May 14, 2019

Related U.S. Application Data
(60) Provisional application No. 62/422,816, filed on Nov. 16, 2016.

(51) Int. Cl. C09K 3/14; B24D 7/06; B24D 18/00

(52) U.S. Cl. CPC C09K 3/1436; B24D 18/0009; B24D 7/063

(57) ABSTRACT

In various embodiments, the present invention provides a structured abrasive article. The structured abrasive article includes an abrasive layer disposed on a backing. The abrasive layer includes shaped abrasive composites, which include abrasive particles dispersed in a polymeric binder. Each of the shaped abrasive composites independently includes a contoured base, which includes a first end disposed on the backing, a second end, and a plurality of sidewalls connecting the first end and the second end. A plurality of walls extends away from the contoured base. The abrasive article additionally includes a grinding surface, which includes a plurality of cusps and a plurality of facets that contact a recessed feature capable of being contained within a geometric plane. A portion of the recessed feature is disposed closer to the contoured base than is each of the cusps, and each cusp is formed by an intersection of two of the walls and a facet.

### BACKGROUND

Structured abrasive articles are a specific type of coated abrasive article that can have a plurality of shaped abrasive composites secured to a backing. Each shaped abrasive composite has a base in contact with the backing and a distal end that extends outwardly from the backing. The shaped abrasive composites include abrasive particles dispersed in a binder, such as a polymeric binder. The shaped abrasive composites are usually arranged in a close-packed array. In one common configuration of a structured abrasive article, the shaped abrasive composites are pyramidal (e.g., tetrahedral or square pyramidal).

Traditionally, structured abrasive products such as, for example, those available as TRIZACT from 3M Company of St. Paul, Minn., have utilized pyramidal abrasive composites. Pyramids can be used for a variety of reasons, not all of them based on grinding performance. For example, pyramids are an easy shape to produce in the tooling used in the manufacture of the structured abrasive products. Further, during manufacture, the tooling is relatively easy to fill with curable slurry and separate from the structured abrasive article after curing when pyramids are used.

A characteristic of pyramidal abrasive composites is a change in load-bearing area from the tops of the shaped composites to their bases as they erode during use. Initially, the erosion is rather rapid. With continued use, the load-bearing area increases until it reaches a point beyond which it no longer breaks down and stops efficiently abrading. This usually occurs when the load-bearing area is in a range of from fifty to seventy percent of the area of the working abrasive surface. In practice, this has limited the useful life of structured abrasive articles incorporating pyramidal shaped features.

### SUMMARY OF THE INVENTION

In various embodiments, the present invention provides a structured abrasive article. The structured abrasive article includes a backing having first and second opposed major surfaces. An abrasive layer is disposed on and secured to the first major surface. The abrasive layer includes shaped abrasive composites. Each of the shaped abrasive composites includes abrasive particles dispersed in a polymeric binder. Each of the shaped abrasive composites independently includes a contoured base. The contoured base includes a first end disposed on the backing, a second end, and a plurality of sidewalls connecting the first end and the second end. A plurality of walls extends away from the second end of the contoured base. Adjacent walls share a common edge and each wall forms a first dihedral angle with the second end of the contoured base of less than or equal to 90 degrees. The abrasive article additionally includes a grinding surface that is free of contact with the base. The grinding surface includes a plurality of cusps and a plurality of facets that contact a recessed feature capable of being contained within a geometric plane. At least a portion of the recessed feature is disposed closer to the base than each of the cusps, and each cusp is formed by an intersection of three or more surfaces including the walls, the facets, or a combiantion thereof, in which at least one of the surfaces is a facet.

Various embodiments provide a method of abrading a workpiece. The method includes contacting at least a portion of the abrasive layer of the structured abrasive article of with a surface of the workpiece. The structured abrasive article includes a backing having first and second opposed major surfaces. An abrasive layer is disposed on and secured to the first major surface. The abrasive layer includes shaped abrasive composites. Each of the shaped abrasive composites includes abrasive particles dispersed in a polymeric binder. Each of the shaped abrasive composites independently includes a contoured base. The contoured base includes a first end disposed on the backing, a second end, and a plurality of sidewalls connecting the first end and the second end. A plurality of walls extends away from the second end of the contoured base. Adjacent walls share a common edge and each wall forms a first dihedral angle with the second end of the contoured base of less than or equal to 90 degrees. The abrasive article additionally includes a grinding surface that is free of contact with the base. The grinding surface includes a plurality of cusps and a plurality of facets that contact a recessed feature capable of being contained within a geometric plane. At least a portion of the recessed feature is disposed closer to the base than each of the cusps, and each cusp is formed by an intersection of three or more surfaces including the walls, the facets, or a combiantion thereof, in which at least one of the surfaces is a facet.

The method further includes moving at least one of the workpiece or the abrasive layer relative to the other to abrade at least a portion of the surface of the workpiece.

Various embodiments provide a method of forming the structured abrasive article. The structured abrasive article includes a backing having first and second opposed major surfaces. An abrasive layer is disposed on and secured to the first major surface. The abrasive layer includes shaped abrasive composites. Each of the shaped abrasive composites includes abrasive particles dispersed in a polymeric binder. Each of the shaped abrasive composites independently includes a contoured base. The contoured base includes a first end disposed on the backing, a second end, and a plurality of sidewalls connecting the first end and the second end. A plurality of walls extends away from the second end of the contoured base. Adjacent walls share a common edge and each wall forms a first dihedral angle with the second end of the contoured base of less than or equal to 90 degrees. The abrasive article additionally includes a grinding surface that is free of contact with the base. The grinding surface includes a plurality of cusps and a plurality of facets that contact a recessed feature capable of being contained within a geometric plane. At least a portion of the recessed feature is disposed closer to the base than each of the cusps, and each cusp is formed by an intersection of two of the walls and at least one of the facets. The method further includes disposing the shaped abrasive composites on the backing.

Various embodiments of the present disclosure provide certain advantages over other structured abrasive articles and methods of using the same, at least some of which are unexpected. For example, according to various embodiments, the contoured base can help to retain shaped abrasive composites on the backing for a longer amount of time compared to a corresponding shaped abrasive composite that is free of the contoured base. Additionally, according to various embodiments, the contoured base can allow the shaped abrasive composite to have a greater height than a corresponding shaped abrasive composite that is free of the contoured base. Additionally, according to various embodiments, shaped composites including the contoured base have a longer lifespan than a corresponding shaped abrasive composite that is free of the contoured base. Additionally, according to various embodiments, contoured channels formed between adjacent contoured bases can help to promote the flow of debris better than a corresponding channel formed from non-contoured bases. This can help to increase performance of the article because the debris is substantially prevented from clogging the abrasive surface.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic side view of an exemplary structured abrasive article, according to the present disclosure;

FIG. 2 is a schematic perspective view of an exemplary structured abrasive article, according to the present disclosure;

FIGS. 3A and 3B are perspective and plan views of exemplary shaped abrasive composites, according to the present disclosure.

FIGS. 4A to 4C are perspective schematic views of exemplary shaped abrasive composites having vertical walls, according to the present disclosure;

FIG. 5 is a perspective schematic view of an exemplary shaped abrasive composite wherein the recessed feature is a point, according to the present disclosure;

FIGS. 6A and 6B are perspective schematic views of exemplary shaped abrasive composites wherein the recessed feature is a polygon, according to the present disclosure.

FIGS. 7A and 7B are perspective schematic views of exemplary shaped abrasive composites wherein the recessed feature is a line, according to the present disclosure.

FIG. 8 is a perspective view of a mold, according to the present disclosure.

FIG. 9 shows an unused disc of Example 1, according to the present disclosure.

FIG. 10 shows a disc of Example 1 after scuffing 3 spots, according to the present disclosure.

FIG. 11 shows a disc of Example 1 after scuffing 7 spots, according to the present disclosure.

FIG. 12 shows a disc of Example 1 after end of life, according to the present disclosure.

FIG. 13 shows a disc of Comparative Example 1 after scuffing, according to the present disclosure.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the disclosed subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

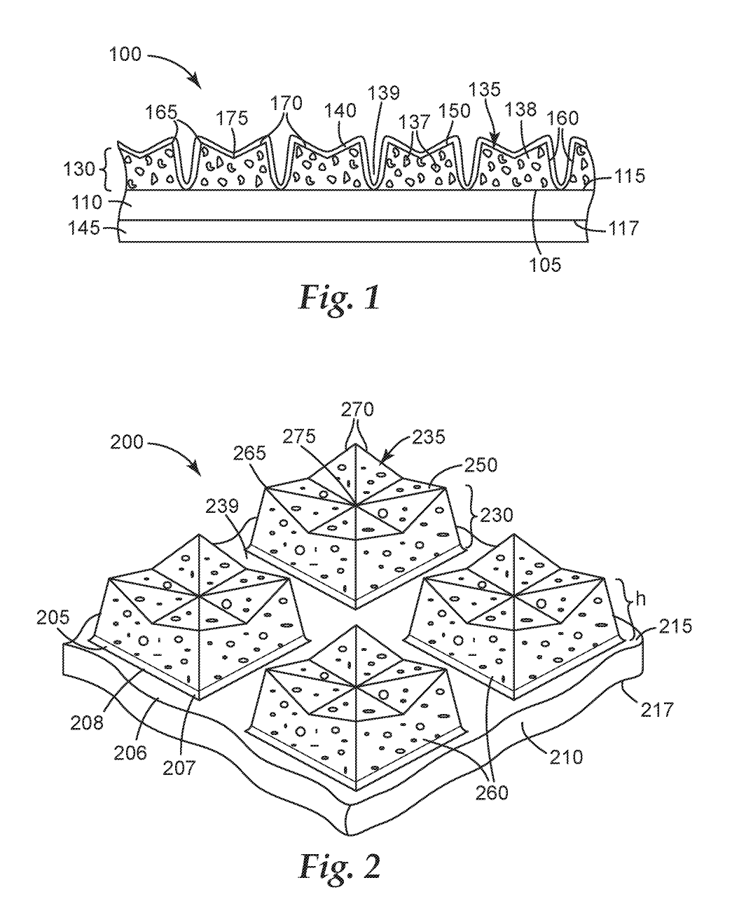

Referring now to FIG. 1, structured abrasive article 100 includes backing 110, which has respective first and second major surfaces 115 and 117. Abrasive layer 130 contacts and is secured to first major surface 115. Abrasive layer 130 includes a plurality of shaped abrasive composites 135, each having grinding surface 150, contoured base 105, and walls 160, that are separated by optional contoured channels 139. Each grinding surface 150 independently includes cusps 165, facets 170, and central feature 175. Shaped abrasive composites 135 include abrasive particles 137 dispersed in a polymeric binder 138. Optional supersize 140 is disposed on abrasive layer 130 opposite backing 110. Optional attachment interface layer 145 is disposed on second major surface 117. While contoured channels 139 may be essentially devoid of abrasive material as shown in FIG. 1, they may also be covered by a layer (such as a thin layer) of abrasive material.

FIG. 2 shows the surface topography of one embodiment of structured abrasive article 200. As shown, structured abrasive article 200 includes backing 210, which has respective first and second major surfaces 215, 217. Abrasive layer 230 contacts and is secured to first major surface 215. Abrasive layer 230 includes a plurality of shaped abrasive composites 235, each having grinding surface 250, contoured base 205, and walls 260, that are separated by optional contoured channels 239. Each of grinding surfaces 250 includes cusps 265, facets 270, and central feature 275.

As illustrated, the shaped abrasive composites include a contoured base disposed on the backing. Although every shaped abrasive composite is illustrated as including the contoured base, in some embodiments a portion of the shaped abrasive composites may be free of the contoured base.

As shown, contoured base 205 extends between first end 206 and second end 207 and has a constant cross-sectional shape. The illustrated contoured base 205 has a square cross-sectional shape, but in other embodiments the cross-sectional shape can correspond to any suitable polygonal shape. For example, the cross-sectional shape can be substantially triangular, square, rectangular, pentagonal, or hexagonal.

While the cross-sectional shape is constant, the cross-sectional area of the contoured base varies from the first end to the second end. As shown in FIG. 2, the cross-sectional area of the first end of the contoured base is larger than the cross-sectional area of the second end of the contoured base. As shown, the cross-sectional area of the first end is about 1.25 times larger than that of the second end. In various embodiments, the cross-sectional area of the first end can range from about 1.25 times to about 5 times larger, or from about 1.5 to 2.5 times larger, or can be about 1.25 times larger, or less than, equal to, or greater than 1.50, 1.75, 2.0, 2.25, 2.50, 2.75, 3, 3.25, 3.50, 3.75, 4, 4.25, 4.50, 4.75, or 5.0 times larger than the cross-sectional area of the second end.

As described further herein, the contoured base can help to improve the lifespan of the shaped abrasive composites because the contoured base helps to retain the shaped abrasive composites on the backing. As the cross-sectional area of the first end increases, the shaped abrasive composites are more securely fastened to the backing. However, the larger cross-sectional area can result in the shaped abrasive composites to be farther apart from one another. Therefore, the cross-sectional surface area of the first end of the contoured base may be chosen depending on the desired characteristics of the abrasive article. Although FIG. 2 shows all first ends of the bases having substantially the same cross-sectional surface area, it is possible for the abrasive article to have a distribution of shaped abrasive composites each with a different cross-sectional surface area.

The contour of the base results from the profile of sidewalls 208. The sidewalls can have many different profiles. For example, the sidewalls can have a curved profile. As shown in FIG. 2, the sidewalls are curved to form a fillet. In other embodiments, the sidewalls can be curved to form a radius.

Alternatively, the sidewalls can have a tapered profile. The sidewalls can be tapered at any suitable angle relative to the walls of the shaped abrasive particle, extending from the base. For example, the sidewalls can be tapered at an angle relative to the walls ranging from about 91 degrees to about 179 degrees, or from about 135 degrees to about 160 degrees, or less than, equal to, or greater than, 95 degrees, 100, 105, 110, 115, 120, 125, 130, 135, 140, 145, 150, 155, 160, 165, 170, or 175 degrees.

The contoured base can account for a portion of the total height h of the shaped abrasive composites. For example, the contoured base can account for about 5% to about 50%, or about 5% to about 15%, or less than, equal to, or greater than, 10%, 15, 20, 25, 30, 35, 40, or 45% of the height of the abrasive composite. The height of the base determines the degree to which the channels between the shaped composite abrasives are contoured. That is, at least some of the channels can have a contoured portion resulting from the contoured base. The channel can further include a straight portion formed by the walls extending from the base. As the height of the contoured base increases, the depth of the contoured channel increases.

As described herein, the contoured base can help to increase the lifespan of the composite shaped abrasive. This is because the composite shaped abrasive can withstand shear forces better with the contoured base. This also allows the abrasive composite to have a higher aspect ratio than a corresponding abrasive composite without a contoured base. The aspect ratio of the shaped abrasive composite is a ratio of the length to the width of the shaped abrasive composite. Specifically, the aspect ratio is determined using the maximum length of the shaped abrasive composite and the minimum cross-sectional area of the shaped abrasive composite. As illustrated in FIG. 2, the length-to-width ratio of the shaped abrasive composites is approximately 2:1. In other embodiments, the ratio can range from about 2:1 to about 10:1, or from about 3:1 to about 6:1, or can be less than, equal to, or greater than 3:1, 4:1, 5:1, 6:1, 7:1, 8:1, or 9:1.

Plural walls extend away from the base. The walls may include planar and/or curved portions. For example, the walls may be planar. Adjacent walls share a common edge. Individual walls may be vertical (e.g., forming a dihedral angle of 90 degrees with the base), or they may be sloped inward such that the walls independently form dihedral angles with the base of less than 90 degrees (e.g., as in the case of a pyramid).

Each of the shaped abrasive composites has a grinding surface that is not in contact with the contoured base. The grinding surface has a plurality of cusps, a plurality of facets, and a recessed feature.

Each cusp is formed by an intersection of two of the walls and at least one of the facets. In some embodiments, each cusp is formed by an intersection of two walls and two facets. In general, at least some of the facets (e.g., all of the facets) contacting adjacent cusps independently define a second dihedral angle in a range of from 120 to 135 degrees. This second dihedral angle may have any value greater than zero degrees and less than 180 degrees, which can range from about 90 degrees to about 150 degrees or from about 120 degrees to about 135 degrees. The cusps may be equidistant from the base (e.g., have the same height), or at least some of the cusps may have different heights.

The facets contact a recessed feature such that each of the cusps is disposed further from the base than at least a portion of the recessed feature. The facets may include planar and/or curved portions. For example, the facets may be planar. The facets may be identical, different, or a combination thereof. In some embodiments, the number of facets and cusps is equal to or twice the number of cusps.

The recessed feature is capable of being contained within a geometric plane. For example, the recessed feature may be a point, a line, or a polygon. If the recessed feature is a line or polygon, it may be sloped relative to the base, for example, as in the instance where the cusps have different heights relative to the base.

The facets, cusps, and recessed feature may be arranged in any manner that meets the specified criteria herein. In the figures, the cusps are shown as sharp points and the edges as sharp lines; however, it is contemplated that the cusps and edges (and other features) may be somewhat rounded, whether by design and/or as a result of manufacturing, provided that they are readily discernible.

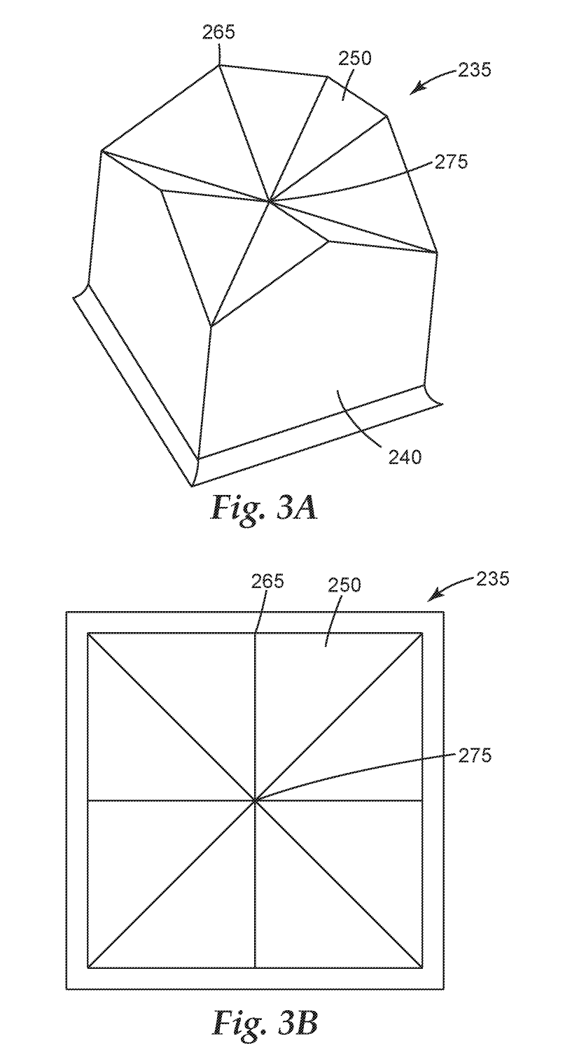

Various illustrative embodiments of shaped abrasive composites are shown in FIGS. 3A to 3B show a version of shaped abrasive particle 235 in isolation.

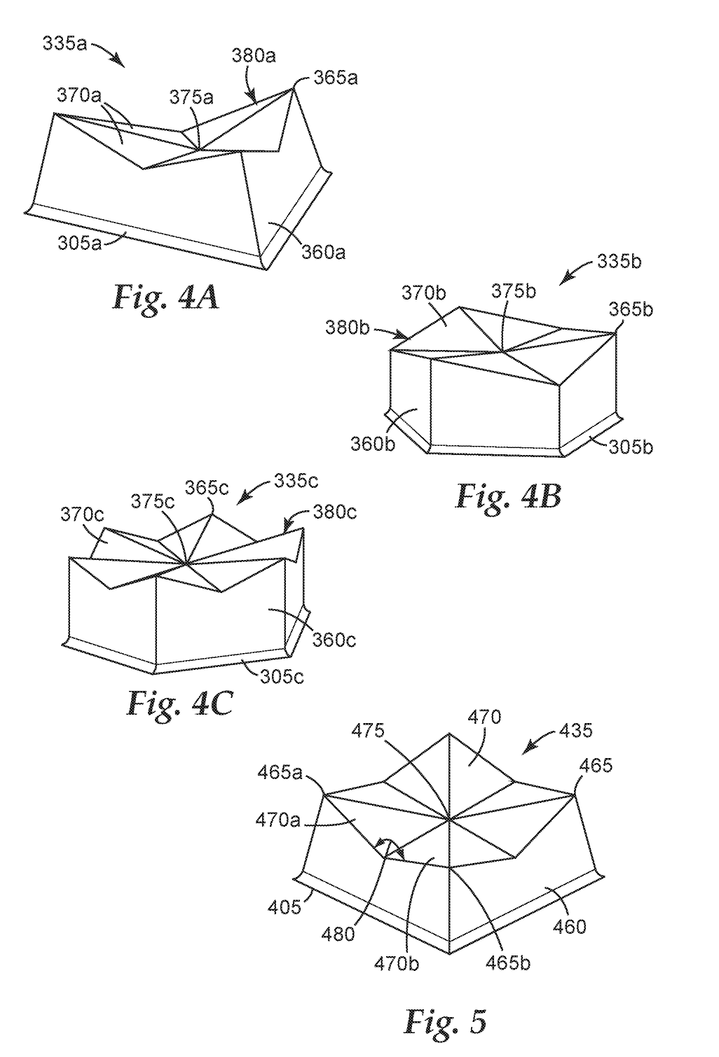

Referring now to FIGS. 4A and 4B, Referring now to FIGS. 4A to 4C, shaped abrasive composites 335a, 335b, 335c have, respectively, contoured bases 305a, 305b, 305c; vertical walls 360a, 360b, 360c; cusps 365a, 365b, 365c; facets 370a, 370b, 370c; grinding surfaces 380a, 380b, 380c; and recessed features (points) 375a, 375b, 375c.

Referring now to FIG. 5, shaped abrasive composite 435 has contoured base 405, four inwardly sloping walls 460, four cusps 465, and eight facets 470 that contact recessed feature (point) 475. Dihedral angle 480 is formed by facets 470a, 470b contacting adjacent cusps 465a, 465b.

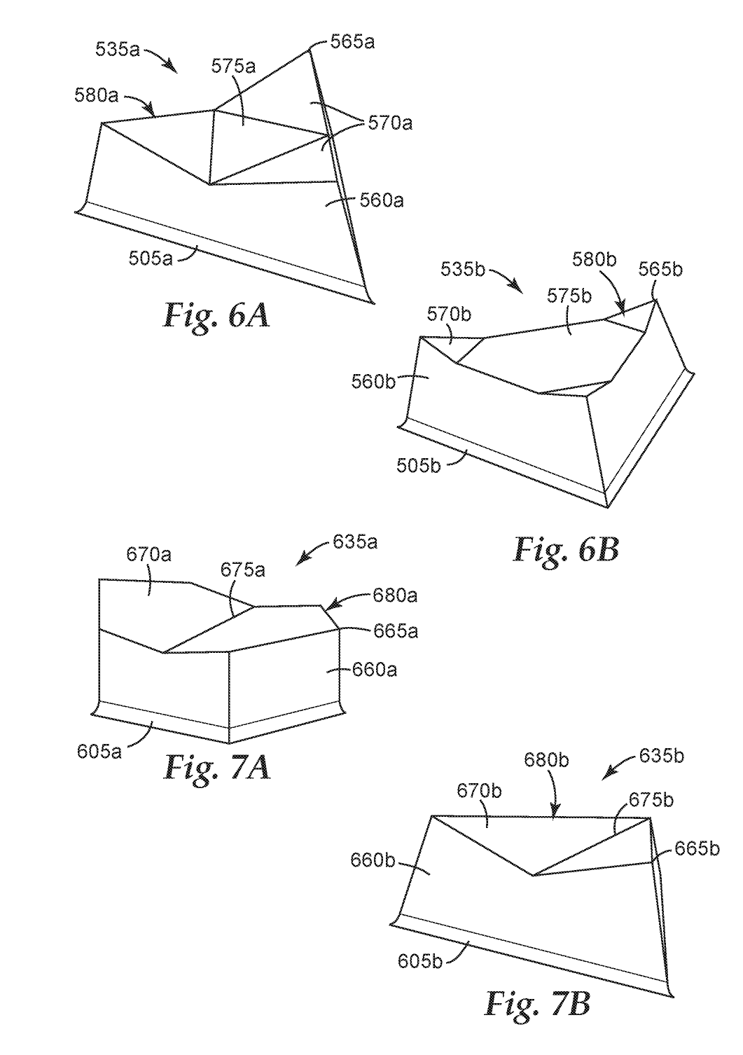

Referring now to FIGS. 6A and 6B, shaped abrasive composites 535a, 535b have, respectively, contoured bases 505a, 505b; vertical walls 560a, 560b; cusps 565a, 565b; facets 570a, 570b; grinding surfaces 580a, 580b; and recessed features (polygons) 575a, 575b.

Referring now to FIGS. 7A and 7B, shaped abrasive composites 635a, 635b have, respectively, bases 605a, 605b; sloped walls 660a, 660b; cusps 665a, 665b; facets 670a, 670b; grinding surfaces 680a, 680b; and recessed features (lines) 675a, 675b.

Examples of useful backings include films, foams (open-cell or closed-cell), papers, foils, and fabrics. The backing may be, for example, a thermoplastic film that includes a thermoplastic polymer, which may contain various additive(s). Examples of suitable additives include colorants, processing aids, reinforcing fibers, heat stabilizers, UV stabilizers, and antioxidants. Examples of useful fillers include clays, calcium carbonate, glass beads, talc, clays, mica, wood flour, and carbon black. The backing may be a composite film, for example a coextruded film having two or more discrete layers.

Suitable thermoplastic polymers include, for example, polyolefins (e.g., polyethylene and polypropylene), polyesters (e.g., polyethylene terephthalate), polyamides (e.g., nylon-6 and nylon-6,6), polyimides, polycarbonates, and combinations and blends thereof. The average thickness of the backing can range from at least about 1 mil (25 micrometers) to about 100 mils (2500 micrometers), although thicknesses outside of this range may also be used.

The structured abrasive layer includes shaped abrasive composites, each including abrasive particles dispersed in a polymeric binder. The structured abrasive layer may be continuous or discontinuous; for example, it may have regions devoid of shaped abrasive composites. The shaped abrasive composites can be arranged on the backing according to a predetermined pattern or array, although this is not a requirement. The shaped abrasive composites may have substantially identical shapes and/or sizes or a mixture of various shapes and/or sizes. In some examples, all of the shaped abrasive composites in the structured abrasive layer have the same size and shape, allowing for manufacturing tolerances (e.g., with respect to missing portions of some shaped abrasive composites or excess material that may be present), although different shapes and sizes are also permissible.

The shaped abrasive composites can be “precisely-shaped” abrasive composites, although this is not a requirement. This can mean that the shaped abrasive composites are defined by relatively smooth-surfaced sides that are bounded and joined by well-defined edges having distinct edge lengths with distinct endpoints defined by the intersections of the various sides. The terms “bounded” and “boundary” can refer to the exposed surfaces and edges of each composite that delimit and define the actual three-dimensional shape of each shaped abrasive composite. These boundaries are readily visible and discernible when a cross-section of an abrasive article is viewed under a scanning electron microscope. These boundaries separate and distinguish one precisely-shaped abrasive composite from another even if the composites abut each other along a common border at their bases. By comparison, in a shaped abrasive composite that does not have a precise shape, the boundaries and edges are not well defined (e.g., where the abrasive composite sags before completion of its curing).

The abrasive layer includes shaped abrasive composites, which can include at least some precisely-shaped abrasive composites, although this is not a requirement. At least some of the abrasive composites include a base, walls, and a grinding surface including cusps and facets. In some embodiments, the number of facets is twice the number of cusps. In some embodiments, the shaped abrasive composites have substantially the same size and shape, although they may be different. The walls of individual shaped abrasive composites may have the same size and/or shape, although they may be different. The facets of individual shaped abrasive composites may have the same size and/or shape, although they may be different. The cusps of individual shaped abrasive composites may have the same size and/or shape, although they may be different. The cusps of individual shaped abrasive composites may be equidistant from the base, or they may have different heights. In some embodiments, they may have different sizes and/or shapes.

The walls may be sloped such that the dihedral angle formed by any given wall and the base is in a range of from about 20 to 90 degrees, or in a range of from about 80 to 87 degrees, or in a range of from about 83 to 85 degrees, although other angles may also be used.

Likewise, facets contacting adjacent cusps may independently define dihedral angles in a range of from 120 to 135 degrees, or 125 to 130 degrees, although other angles may be used.

In some embodiments, the shaped abrasive composites in the abrasive layer include almost totally (e.g., other than shapes due to manufacturing defects) the shaped abrasive composites described above.

Advantageously, according to some embodiments, the shaped abrasive composites constructed as above may be formed such that they exhibit minimal change in load-bearing areas after a period of initial use, while simultaneously providing sufficient abrasive points and edges (cusps and facet joint ridges) that a sufficient degree of initial cut is also achieved. While not wishing to be bound by theory, the present inventors believe that erosion of the relatively weak cusps is desirable in that it exposes mineral at the grinding surface that would otherwise be covered by a layer of polymeric binder, thereby contributing to initial cut performance. Accordingly, were the shaped abrasive composites to have flat tops, poor initial cut would be expected.

The foregoing shaped abrasive composites may be combined with abrasive composites having different shapes. Examples include pyramids (e.g., three-sided pyramids or four-sided pyramids), prisms, and rods.

The shaped abrasive composites may include a close-packed array; however, it is presently found that by separating the shaped abrasive composites it is possible to control the load-bearing area of the structured abrasive article. As used herein, the term “load-bearing area,” expressed as a percentage, refers to the combined area of all bases of all shaped abrasive composites divided by the total area of the first surface of the backing. The load-bearing area can range from about 30 to about 100 percent, or from about 40 percent to about 80 percent, or from about 50 to about 70 percent, although this is not a requirement. Load-bearing areas less than 100 percent may be achieved, for example, by including channels between individual shaped abrasive composites, or between close-packed arrays of the shaped abrasive composites.

For fine finishing applications, the height of the shaped abrasive composites is generally greater than or equal to one micrometer and less than or equal to 20 mils (510 micrometers); for example, the height may be less than 15 mils (380 micrometers), 10 mils (250 micrometers), 5 mils (125 micrometers), 2 mils (50 micrometers), or even less than one mil, although greater and lesser heights may also be used.

For fine finishing applications, the areal density of the shaped abrasive composites in the abrasive layer can be in a range of from at least 1,000, 10,000, or even at least 20,000 shaped abrasive composites per square inch (e.g., at least 150, 1,500, or even 3,000 shaped abrasive composites per square centimeter) up to and including 50,000, 70,000, or even as many as 100,000 shaped abrasive composites per square inch (7,800, 11,000, or even as many as 15,000 shaped abrasive composites per square centimeter), although greater or lesser densities of shaped abrasive composites may also be used.

Any abrasive particle may be included in the abrasive composites. The abrasive particles can have a Mohs hardness of at least 8, or even 9. Examples of such abrasive particles include aluminum oxide, fused aluminum oxide, ceramic aluminum oxide, white fused aluminum oxide, heat-treated aluminum oxide, silica, silicon carbide, green silicon carbide, alumina-zirconia, diamond, iron oxide, ceria, cubic boron nitride, garnet, tripoli, sol-gel-derived abrasive particles, and combinations thereof.

The abrasive particles can have an average particle size of less than or equal to 1500 micrometers, although average particle sizes outside of this range may also be used. For repair and finishing applications, useful abrasive particle sizes can include an average particle size in a range of from at least 0.01, 1, 3 or even 5 micrometers up to and including 35, 100, 250, 500, or even as much as 1500 micrometers.

The abrasive particles are dispersed in a polymeric binder, which may be thermoplastic and/or crosslinked. This is generally accomplished by dispersing the abrasive particles in a binder precursor, usually in the presence of an appropriate curative (e.g., photoinitiator, thermal curative, and/or catalyst). Examples of suitable polymeric binders that are useful in abrasive composites include phenolics, aminoplasts, urethanes, epoxies, acrylics, cyanates, isocyanurates, glue, and combinations thereof.

The polymeric binder can be prepared by crosslinking (e.g., at least partially curing and/or polymerizing) a binder precursor. During the manufacture of the structured abrasive article, the polymeric binder precursor is exposed to an energy source which aids in the initiation of polymerization (which can include crosslinking) of the binder precursor. Examples of energy sources include thermal energy and radiation energy, which includes electron beam energy, ultraviolet light, and visible light. In the case of an electron beam energy source, curative is not necessarily required because the electron beam itself generates free radicals.

After this polymerization process, the binder precursor is converted into a solidified binder. Alternatively for a thermoplastic binder precursor, during the manufacture of the abrasive article the thermoplastic binder precursor is cooled to a degree that results in solidification of the binder precursor. Upon solidification of the binder precursor, the abrasive composite is formed.

There are two main classes of polymerizable resins that may be included in the binder precursor: condensation-polymerizable resins and addition-polymerizable resins. Addition polymerizable resins are advantageous because they are readily cured by exposure to radiation energy. Addition polymerized resins can polymerize, for example, through a cationic mechanism or a free-radical mechanism. Depending upon the energy source that is utilized and the binder precursor chemistry, a curing agent, initiator, or catalyst may be useful to help initiate the polymerization.

Examples of suitable binder precursors include phenolic resins, urea-formaldehyde resins, aminoplast resins, urethane resins, melamine formaldehyde resins, cyanate resins, isocyanurate resins, (meth)acrylate resins (e.g., (meth)acrylated urethanes, (meth)acrylated epoxies, ethylenically-unsaturated free-radically polymerizable compounds, aminoplast derivatives having pendant alpha, beta-unsaturated carbonyl groups, isocyanurate derivatives having at least one pendant acrylate group, and isocyanate derivatives having at least one pendant acrylate group), vinyl ethers, epoxy resins, and mixtures and combinations thereof.

Phenolic resins have good thermal properties and availability, and relatively low cost and ease of handling. Phenolic resins can include resole and novolac. Resole phenolic resins have a molar ratio of formaldehyde to phenol of greater than or equal to one to one, or in a range of from 1.5:1.0 to 3.0:1.0. Novolac resins have a molar ratio of formaldehyde to phenol of less than one to one. Examples of commercially available phenolic resins include those known by the trade designations DUREZ and VARCUM from Occidental Chemicals Corp. of Dallas, Tex.; RESINOX from Monsanto Co. of Saint Louis, Mo.; and AEROFENE and AROTAP from Ashland Specialty Chemical Co. of Dublin, Ohio. (Meth)acrylated urethanes include di(meth)acrylate esters of hydroxyl-terminated NCO extended polyesters or polyethers. Examples of commercially available acrylated urethanes include those available as CMD 6600, CMD 8400, and CMD 8805 from Cytec Industries of West Paterson, N.J. (Meth)acrylated epoxies include di(meth)acrylate esters of epoxy resins such as the diacrylate esters of bisphenol A epoxy resin. Examples of commercially available acrylated epoxies include those available as CMD 3500, CMD 3600, and CMD 3700 from Cytec Industries.

Ethylenically-unsaturated free-radically polymerizable compounds include both monomeric and polymeric compounds that contain atoms of carbon, hydrogen, and oxygen, and optionally, nitrogen and the halogens. Oxygen or nitrogen atoms or both are generally present in ether, ester, urethane, amide, and urea groups. Ethylenically-unsaturated free-radically polymerizable compounds can have a molecular weight of less than about 4,000 g/mole and can be esters made from the reaction of compounds containing a single aliphatic hydroxyl group or multiple aliphatic hydroxyl groups and unsaturated carboxylic acids, such as acrylic acid, methacrylic acid, itaconic acid, crotonic acid, isocrotonic acid, maleic acid, and the like. Representative examples of (meth)acrylate resins include methyl methacrylate, ethyl methacrylate styrene, divinylbenzene, vinyl toluene, ethylene glycol diacrylate, ethylene glycol methacrylate, hexanediol diacrylate, triethylene glycol diacrylate, trimethylolpropane triacrylate, glycerol triacrylate, pentaerythritol triacrylate, pentaerythritol methacrylate, pentaerythritol tetraacrylate and pentaerythritol tetraacrylate. Other ethylenically unsaturated resins include monoallyl, polyallyl, and polymethallyl esters and amides of carboxylic acids, such as diallyl phthalate, diallyl adipate, and N,N-diallyladipamide. Still other nitrogen containing compounds include tris(2-acryloyl-oxyethyl) isocyanurate, 1,3,5-tris(2-methyacryloxyethyl)-s-triazine, acrylamide, N-methylacrylamide, N,N-dimethylacrylamide, N-vinylpyrrolidone, and N-vinylpiperidone.

Useful aminoplast resins have at least one pendant alpha, beta-unsaturated carbonyl group per molecule or oligomer. These unsaturated carbonyl groups can be acrylate, methacrylate, or acrylamide type groups. Examples of such materials include N-(hydroxymethyl)acrylamide, N,N′-oxydimethylenebisacrylamide, ortho- and para-acrylamidomethylated phenol, acrylamidomethylated phenolic novolac, and combinations thereof.

Epoxy resins have one or more epoxy groups that may be polymerized by ring opening of the epoxy group(s). Such epoxy resins include monomeric epoxy resins and oligomeric epoxy resins. Examples of useful epoxy resins include 2,2-bis[4-(2,3-epoxypropoxy)-phenyl propane] (diglycidyl ether of bisphenol) and materials available as EPON 828, EPON 1004, and EPON 1001F from Shell Chemical Co. of Houston, Tex.; and DER-331, DER-332, and DER-334 from Dow Chemical Co. of Midland, Mich. Other suitable epoxy resins include glycidyl ethers of phenol formaldehyde novolac commercially available as DEN-431 and DEN-428 from Dow Chemical Co.

The epoxy resins can polymerize via a cationic mechanism with the addition of an appropriate cationic curing agent. Cationic curing agents generate an acid source to initiate the polymerization of an epoxy resin. These cationic curing agents can include a salt having an onium cation and a halogen containing a complex anion of a metal or metalloid. Other curing agents (e.g., amine hardeners and guanidines) for epoxy resins and phenolic resins may also be used.

To promote an association bridge between the above-mentioned binder and the abrasive particles, a silane coupling agent may be included in the slurry of abrasive particles and binder precursor, in an amount of from about 0.01 to 5 percent by weight, or in an amount of from about 0.01 to 3 percent by weight, or in an amount of from about 0.01 to 1 percent by weight, although other amounts may also be used, for example depending on the size of the abrasive particles. Suitable silane coupling agents include, for example, methacryloxypropylsilane, vinyltriethoxysilane, vinyltris(2-methoxyethoxy)silane, 3,4-epoxycyclohexylmethyltrimethoxysilane, gamma-glycidoxypropyltrimethoxysilane, and gamma-mercaptopropyltrimethoxysilane (e.g., as available under the respective trade designations A-174, A-151, A-172, A-186, A-187, and A-189 from Witco Corp. of Greenwich, Conn.), allyltriethoxysilane, diallyldichlorosilane, divinyldiethoxysilane, and meta, para-styrylethyltrimethoxysilane (e.g., as commercially available under the respective trade designations A0564, D4050, D6205, and S 1588 from United Chemical Industries of Bristol, Pa.), dimethyldiethoxysilane, dihydroxydiphenylsilane, triethoxysilane, trimethoxysilane, triethoxysilanol, 3 -(2-aminoethylamino)propyltrimethoxysilane, methyltrimethoxysilane, vinyltriacetoxysilane, methyltriethoxysilane, tetraethyl orthosilicate, tetramethyl orthosilicate, ethyltriethoxysilane, amyltriethoxysilane, ethyltrichlorosilane, amyltrichlorosilane, phenyltrichlorosilane, phenyltriethoxysilane, methyltrichlorosilane, methyldichlorosilane, dimethyldichlorosilane, dimethyldiethoxysilane, and mixtures thereof.

The binder precursor may optionally contain additives such as, for example, colorants, grinding aids, fillers, wetting agents, dispersing agents, light stabilizers, and antioxidants.

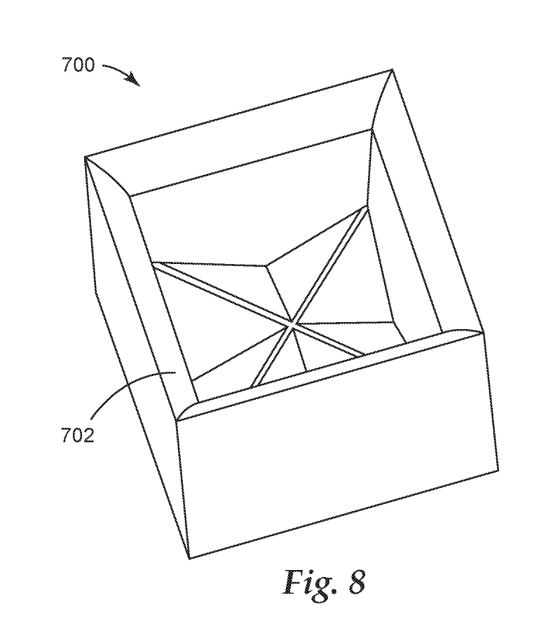

FIG. 8 illustrates mold 700. The mold can be used to form the shaped abrasive composite. As illustrated, the mold is the negative impression of a shaped abrasive composite. The mold includes flared base 702, which ultimately forms the contoured base. The abrasive particles and polymeric binder can be dispensed in the mold to form the shaped abrasive composite.

Grinding aids, which may optionally be included in the abrasive layer via the binder precursor, encompass a wide variety of different materials including both organic and inorganic compounds. A sampling of chemical compounds effective as grinding aids includes waxes, organic halide compounds, halide salts, metals, and metal alloys. Specific waxes effective as a grinding aid include specifically, but not exclusively, the halogenated waxes tetrachloronaphthalene and pentachloronaphthalene. Other effective grinding aids include halogenated thermoplastics, sulfonated thermoplastics, waxes, halogenated waxes, sulfonated waxes, and mixtures thereof. Other organic materials effective as a grinding aid include specifically, but not exclusively, polyvinylchloride and polyvinylidene chloride. Examples of halide salts generally effective as a grinding aid include sodium chloride, potassium cryolite, sodium cryolite, ammonium cryolite, potassium tetrafluoroborate, sodium tetrafluoroborate, silicon fluorides, potassium chloride, and magnesium chloride. Halide salts employed as a grinding aid can have an average particle size of less than 100 mm, with particles of less than 25 mm preferred. Examples of metals generally effective as a grinding aid include antimony, bismuth, cadmium, cobalt, iron, lead, tin, and titanium. Other commonly used grinding aids include sulfur, organic sulfur compounds, graphite, and metallic sulfides. Combinations of these grinding aids can also be employed.

The optional supersize, if present, is disposed on at least a portion of the abrasive layer. For example, a supersize may be disposed only on the shaped abrasive composites (e.g., on their grinding surfaces), although it may also be disposed on the channels. Examples of supersizes include one or more compounds selected from the group consisting of secondary grinding aids such as alkali metal tetrafluoroborate salts, metal salts of fatty acids (e.g., zinc stearate or calcium stearate), salts of phosphate esters (e.g., potassium behenyl phosphate), phosphate esters, urea-formaldehyde resins, mineral oils, crosslinked silanes, crosslinked silicones, and/or fluorochemicals; fibrous materials; antistatic agents; lubricants; surfactants; pigments; dyes; coupling agents; plasticizers: antiloading agents; release agents; suspending agents; rheology modifiers; curing agents; and mixtures thereof. A secondary grinding aid is may be selected from the group of sodium chloride, potassium aluminum hexafluoride, sodium aluminum hexafluoride, ammonium aluminum hexafluoride, potassium tetrafluoroborate, sodium tetrafluoroborate, silicon fluorides, potassium chloride, magnesium chloride, and mixtures thereof. In some embodiments, one or more metal salts of fatty acids (e.g., zinc stearate) may be usefully included in the supersize.

The structured abrasive article may optionally include an attachment interface layer such as, for example, a hooked film, looped fabric, or pressure-sensitive adhesive that affixes the structured abrasive article to a tool or backup pad during use.

Useful pressure-sensitive adhesives (PSAs) include, for example, hot melt PSAs, solvent-based PSAs, and latex-based PSAs. Pressure-sensitive adhesives are widely commercially available, for example, from 3M Company of Saint Paul, Minn. The PSA layer, if present, may be coated onto the backing by any suitable technique including, for example, spraying, knife coating, and extrusion coating. In some embodiments, a release liner may be disposed on the pressure-sensitive layer to protect it prior to use. Examples of release liners include polyolefin films and siliconized papers.

Structured abrasive articles according to the present disclosure may be prepared by forming a slurry of abrasive grains and a solidifiable or polymerizable precursor of the above-mentioned binder resin (e.g., a binder precursor), contacting the slurry with a backing (or if present, optional adhesive layer) and at least partially curing the binder precursor (e.g., by exposure to an energy source) in a manner such that the resulting structured abrasive article has a plurality of shaped abrasive composites affixed to the backing. Examples of energy sources include thermal energy and radiant energy (including electron beam energy, ultraviolet light, and visible light).

In one embodiment, a slurry of abrasive particles in a binder precursor may be coated directly onto a production tool having precisely-shaped cavities therein and brought into contact with the backing (or if present, optional adhesive layer), or coated onto the backing and brought into contact with the production tool. In this embodiment, the slurry can then be solidified (e.g., at least partially cured) while it is present in the cavities of the production tool.

The production tool can be a belt, a sheet, a continuous sheet or web, a coating roll such as a rotogravure roll, a sleeve mounted on a coating roll, or a die. The production tool can be composed of metal (e.g., nickel), metal alloys, or plastic. The metal production tool can be fabricated by any conventional technique such as, for example, engraving, bobbing, electroforming, or diamond turning. A thermoplastic tool can be replicated from a metal master tool. The master tool will have the inverse of the pattern desired for the production tool. The master tool can be made in the same manner as the production tool. The master tool may be made out of metal, e.g., nickel, and is diamond turned. The thermoplastic sheet material can be heated optionally along with the master tool such that the thermoplastic material is embossed with the master tool pattern by pressing the two together. The thermoplastic can also be extruded or cast onto the master tool and then pressed. The thermoplastic material is cooled to solidify and produce the production tool. Examples of thermoplastic production tool materials include polyester, polycarbonates, polyvinyl chloride, polypropylene, polyethylene, and combinations thereof If a thermoplastic production tool is utilized, then care should be taken not to generate excessive heat that may distort the thermoplastic production tool.

The production tool may also contain a release coating to permit easier release of the abrasive article from the production tool. Examples of such release coatings for metals include hard carbide, nitrides, or borides coatings. Examples of release coatings for thermoplastics include silicones and fluorochemicals.

In another embodiment, a slurry including a binder precursor and abrasive particles may be deposited on a backing in a patterned manner (e.g., by screen or gravure printing) and partially polymerized to render at least the surface of the coated slurry plastic but non-flowing. Then, a pattern is embossed upon the partially polymerized slurry formulation, which is subsequently further cured (e.g., by exposure to an energy source) to form a plurality of shaped abrasive composites affixed to the backing. In this embodiment, once the abrasive layer is affixed to the backing, the resultant structured abrasive articles, whether in sheet or disc form at this point, have shaped features embossed therein such that both the backing and the structured abrasive layer have superposed embossed features. Embossing may be accomplished by any suitable means including, for example, application of heat and/or pressure to an embossing die (e.g., by embossing) having the desired pattern (or its inverse) depending on the embossing conditions used. The embossing die may include, for example, a plate or a roll. The dimensions of the embossed features can be at least an order of magnitude larger in cross section (e.g., at least 10, 100, or even at least 1000 times larger) than the average size of the shaped abrasive composites.

Structured abrasive articles according to the present disclosure may be secured to a support structure such as, for example, a backup pad secured to a tool such as, for example, a random orbital sander. The optional attachment interface layer may be, for example, an adhesive (e.g., a pressure-sensitive adhesive) layer, a double-sided adhesive tape, a loop fabric for a hook and loop attachment (e.g., for use with a backup or support pad having a hooked structure affixed thereto), a hooked structure for a hook and loop attachment (e.g., for use with a backup or support pad having a looped fabric affixed thereto), or an intermeshing attachment interface layer (e.g., mushroom-type interlocking fasteners designed to mesh with like mushroom-type interlocking fasteners on a backup or support pad). Likewise, the second major surface of the backing may have a plurality of integrally formed hooks protruding therefrom. These hooks will then provide the engagement between the structured abrasive article and a backup pad that has a loop fabric affixed thereto.

Structured abrasive articles according to the present disclosure may be provided in any form (for example, as a sheet, belt, or disc) and be of any overall dimensions. Embossed structured abrasive discs may have any diameter, but can have a diameter in a range of from 0.5 centimeter to 15.2 centimeters. The structured abrasive article may have slots or slits therein and may be otherwise provided with perforations.

Structured abrasive articles according to the present disclosure are generally useful for abrading a workpiece, and especially those workpieces having a hardened polymeric layer thereon. To abrade the workpiece, at least a portion of the abrasive layer is contacted with the workpiece. Once contacted, either the abrasive layer or workpiece is moved relative to the other to abrade the workpiece. The workpiece may include any material and may have any form. Examples of materials include metal, metal alloys, exotic metal alloys, ceramics, painted surfaces, plastics, polymeric coatings, stone, polycrystalline silicon, wood, marble, and combinations thereof. Examples of workpieces include molded and/or shaped articles (e.g., optical lenses, automotive body panels, boat hulls, counters, and sinks), wafers, sheets, and blocks.

A lubricating fluid may be used in conjunction with the structured abrasive article during abrading operations. Examples include oils, water, and surfactant solutions in water (e.g., anionic or nonionic surfactant solutions in water).

There are many reasons to use the structured abrasive article of the present disclosure, including the following non-limiting reasons. According to various embodiments, the contoured base can improve the retention of the abrasive composites in the backing. That is, when a shear force is applied to the abrasive composites, the contoured base is able to disperse the load through the base. This ultimately can help to prevent the shaped abrasive composites from being dislodged from the backing during operation. If the shaped abrasive composites are ripped out of the backing, then the article can potentially damage the surface that it is grinding.

Another reason to use the structured abrasive article, according to various embodiments, is that the contoured base can allow the height of the shaped abrasive composite to be more than that of a shaped abrasive composite that does not include the contoured base. The contoured base can help to retain the abrasive composites on the binder by better dispersing the load through the contoured base. Thus, taller shaped abrasive composites that would otherwise be more susceptible to failure without having the contoured base are more securely disposed on the backing with the contoured base.

A benefit of having taller shaped abrasive composites, according to various embodiments, is that the overall grinding life of the abrasive article is improved. This is because the taller shaped abrasive composites take more time to be worn down than a comparatively shorter shaped abrasive composite. Thus the overall life of article is improved compared to an article including corresponding shaped abrasive composites that do not have a contoured base.

An additional advantage of including the contoured base, according to various embodiments, is that the channels between abrasive composite particles have a contour matching the base. The shape of the channels can help to promote flow of debris including grinded material out of the abrasive article. For example, in an application where the abrasive article is used to buff paint, dislodged paint debris will enter the channels. It is important to remove the paint debris in order to prevent interference with the composite abrasive particles. The shaped channels however, can help to promote the flow of paint debris. This is because the shaped channels funnel the debris. That is, the shaped channels actually promote flow as opposed to straight-wall channels that do not promote flow.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Various embodiments can be better understood by reference to the following Examples, which are offered by way of illustration. The present invention is not limited to the Examples given herein.

Unless otherwise noted, all parts, percentages, ratios, etc. in the Examples and the rest of the specification are by weight. Unless stated otherwise, all other reagents were obtained, or are available from fine chemical vendors such as Sigma-Aldrich Company, St. Louis, Mo., or may be synthesized by known methods.

Abbreviations for materials and reagents used in the examples are listed in Table 1.

TABLE 1

| Abbreviation | Description |
|---|---|
| A174 | gamma-methacryloxypropyltrimethoxysilane, obtained as A174 from |
| | Crompton Corporation, Middlebury, Connecticut |
| DSP | anionic polyester dispersant, obtained as SOLPLUS D520 from Lubrizol |
| | Advanced Materials of Cleveland, Ohio |
| OX50 | silicon dioxide, obtained as AEROSIL OX50 from Degussa Corporation, |
| | Parsippany, New Jersey |
| SR351 | trimethylolpropane triacrylate, obtained as SR351 from Sartomer USA LLC, |
| | Exton, Pennsylvania |
| SR339 | 2-phenoxyethyl acrylate, obtained as SR339 from Sartomer USA LLC, Exton, |
| | Pennsylvania |
| TER | Secondary alcohol ethoxylate non-ionicsurfactant, obtained as TERGITOL |
| | 15-S-5 from Dow Corporation, Auburn Hills, Michigan |
| PI | acylphosphine oxide photoinitiator, obtained under the trade designation |
| | LUCERIN TPO-L from BASF Corporation, Florham Park, New Jersey |
| WA3000 | white fused alumina with particle size d₅₀ = 5.60 +/− 0.50 microns, obtained as |
| | WA 3000 from Fujimi Corporation, Wilsonville, Oregon |

### Example 1

A polypropylene tool having recesses to provide an array of shaped abrasive composites (shaped generally as the precisely-shaped abrasive composite shown in FIGS. 3A and 3B) with a 5.8-mil (0.1472 mm) pitch. Each shaped cavity opening (corresponding to the base) was 4.0 mils×4.0 mils (0.1027 mm×0.1027 mm) and each wall rose at an 82 degree angle to a height of 3.3 mils (0.0831 mm) above the base. The top face of each shaped abrasive composite had two orthogonal V-shaped cuts centrally disposed at right angles from corner-to-corner across the top face (providing side cusps in the abrasive composite), each cut being 0.75 mils (0.019 mm) deep and furrowed at 110 degrees. Each of the feature also had contoured base provided as a fillet that has a radius of 1 mil (25 micrometers).

An abrasive slurry was prepared by combining, in order, 12.3 parts SR351, 8.1 parts SR339, 0.55 parts DSP, 1.50 parts A174, 0.80 parts PI, 6.0 parts OX50, 70.4 parts WA3000 and 0.25 parts TER, and stirring with a high-shear mixer. The abrasive slurry was coated (using a putty knife) into the cavities of the polypropylene tool to achieve a coating weight of about 1.1 g/24 in² (71 g/m²). The filled tool was contacted by a 3-mil polyester film backing having a EAA primer coating and irradiated by ultraviolet light from two D bulbs (Fusion Systems, Gaithersburg, Md.) operating at 120 watts/cm. The polypropylene tool was removed from the composition yielding a structured abrasive article. A pressure sensitive adhesive (PSA) attachment layer was laminated to the backing and 1.25 in (3.175 cm) diameter abrasive discs were cut from the lamination for testing.

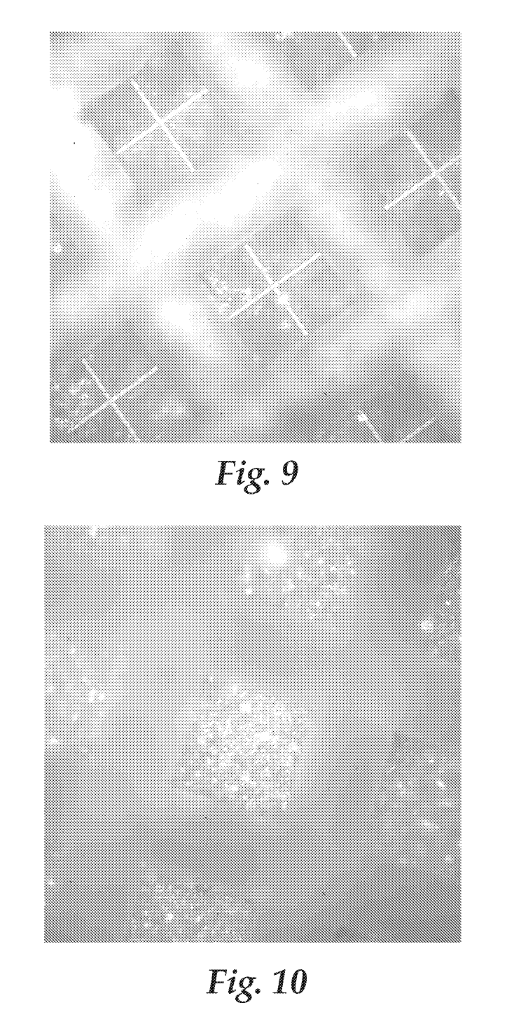

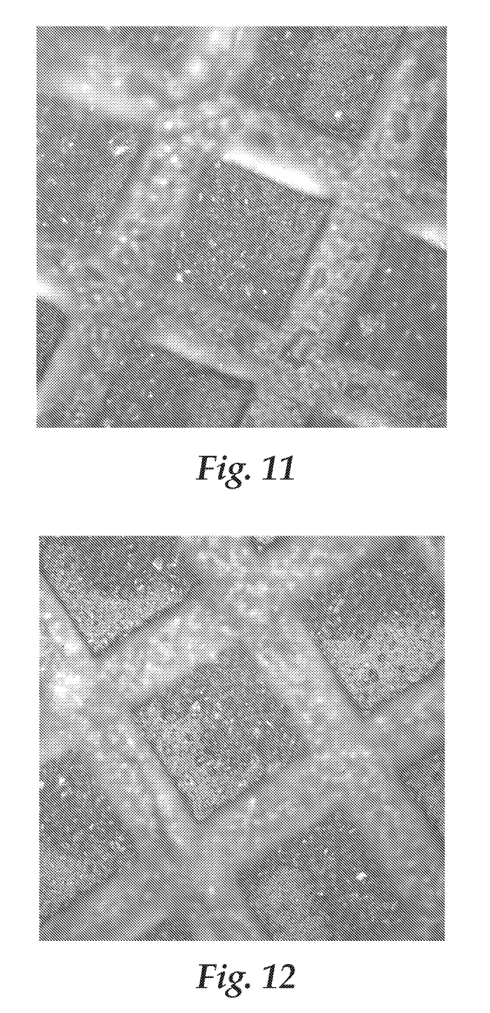

Test discs from Example 1 were examined under 400× magnification using a KEYENCE VHX-1000 digital microscope. FIGS. 9, 10, 11, and 12 show the unused disc, disc after 3 scuffs, disc after 7 scuffs and disc at the end of usefulness respectively. The disc was wearing down in a controlled way from scuff to scuff until the structures stopped scuffing the surface.

### Comparative Example A

The procedure generally described in EXAMPLE 1 was repeated, with the exception that there was no contoured base for each of the feature on the polypropylene tool. 1.25 in (3.175 cm) diameter abrasive discs were cut from the lamination for testing.

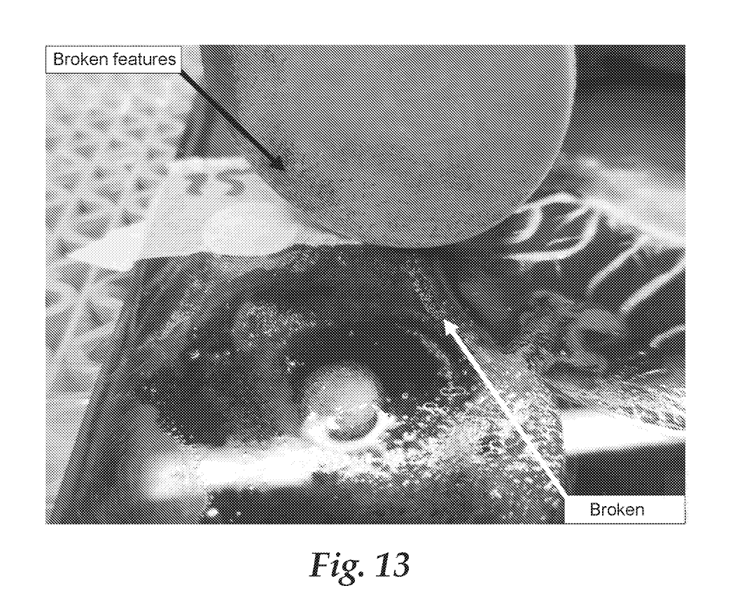

Many of the structures were broken before the disc was used up completely in the testing as shown in FIG. 13.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments.

The following exemplary embodiments are provided, the numbering of which is not to be construed as designating levels of importance:

Embodiment 1 provides a structured abrasive article comprising:

a backing having first and second opposed major surfaces; and

an abrasive layer disposed on and secured to the first major surface, wherein the abrasive layer comprises shaped abrasive composites, wherein each of the shaped abrasive composites comprises abrasive particles dispersed in a polymeric binder, and wherein each of the shaped abrasive composites independently comprises:
a contoured base comprising:
   a first end disposed on the backing;
   a second end; and
   a plurality of sidewalls connecting the first end and the second end;
a plurality of walls extending away from the second end of the contoured base, wherein adjacent walls share a common edge, wherein each wall forms a first dihedral angle with the second end of the contoured base of less than or equal to 90 degrees; and
a grinding surface free of contact with the contoured base, wherein the grinding surface comprises:
   a plurality of cusps; and
   a plurality of facets that contact a recessed feature containable within a geometric plane, wherein at least a portion of the recessed feature is disposed closer to the contoured base than is each of the cusps, and wherein each cusp is formed by an intersection of three or more surfaces comprising the walls, the facets, or a combiantion thereof, wherein at least one of the surfaces is a facet.

Embodiment 2 provides the structured abrasive article according to Embodiment 1, wherein a cross-sectional area of the first end of the contoured base is larger than a cross-sectional area of the second end of the contoured base.

Embodiment 3 provides the structured abrasive article according to any one of Embodiments 1 or 2, wherein the cross-sectional area of the first end is about 1.25 times to about 5 times larger than the cross-sectional area of the second end.

Embodiment 4 provides the structured abrasive article according to any one of Embodiments 2 or 3, wherein the cross-sectional area of the first end is about 1.25 times to about 2 times larger than the cross-sectional area of the second end.

Embodiment 5 provides the structured abrasive article according to any one of Embodiments 1-4, wherein the contoured base has a constant cross-sectional shape between the first end and the second end.

Embodiment 6 provides the structured abrasive article according to any one of Embodiments 1-5, wherein the sidewalls have a curved profile.

Embodiment 7 provides the structured abrasive article according to Embodiment 6, wherein the sidewalls are curved to form a radius.

Embodiment 8 provides the structured abrasive article according to Embodiment 6, wherein the sidewalls are curved to form a fillet.

Embodiment 9 provides the structured abrasive article according to any one of Embodiments 1-8, wherein the sidewalls have a tapered profile.

Embodiment 10 provides the structured abrasive article according to Embodiment 9, wherein the sidewalls are tapered at an angle relative to the walls of about 91 degrees to about 179 degrees.

Embodiment 11 provides the structured abrasive article according to Embodiment 9, wherein the sidewalls are tapered at an angle relative to the walls of about 135 degrees to about 160 degrees.

Embodiment 12 provides the structured abrasive article according to any one of Embodiments 1-11, wherein the contoured base is about 5% to about 50% of a height of the shaped abrasive composite.

Embodiment 13 provides the structured abrasive article according to any one of Embodiments 1-12, wherein the contoured base is about 5% to about 15% of a height of the shaped abrasive composite.

Embodiment 14 provides the structured abrasive article according to any one of Embodiments 1-13, wherein the shaped abrasive composite has a length-to-width ratio ranging from about 2:1 to about 10:1.

Embodiment 15 provides the structured abrasive article according to any one of Embodiments 1-14, wherein the shaped abrasive composite subjected to a shear force is more secure on the backing than a corresponding shaped abrasive composite that is free of the contoured base that is exposed to the same shear force.

Embodiment 16 provides the structured abrasive article according to any one of Embodiments 1-15, wherein a lifespan of the shaped abrasive composite under abrasive conditions is longer than that of a corresponding shaped abrasive composite that is free of the contoured base under the same abrasive conditions.

Embodiment 17 provides the structured abrasive article according to any one of Embodiments 1-16, wherein the first ends of adjacent shaped abrasive composites contact each other.

Embodiment 18 provides the structured abrasive article according to any one of Embodiments 1-17, wherein the first ends of adjacent shaped abrasive composites are free of contact with each other.

Embodiment 19 provides the structured abrasive article according to any one of Embodiments 1-18, wherein the first dihedral angle is about 80 to about 85 degrees.

Embodiment 20 provides the structured abrasive article according to any one of Embodiments 1-19, wherein each of the cusps is substantially equidistant from the second end of the contoured base.

Embodiment 21 provides the structured abrasive article according to any one of Embodiments 1-20, wherein the recessed feature is a polygon.

Embodiment 22 provides the structured abrasive article according to any one of Embodiments 1-21, wherein the recessed feature is a line.

Embodiment 23 provides the structured abrasive article according to any one of Embodiments 1-22, wherein the recessed feature is a point.

Embodiment 24 provides the structured abrasive article according to any one of Embodiments 1-23, wherein the recessed feature has a lowest point that is higher than half of a height of the shaped abrasive composite.

Embodiment 25 provides the structured abrasive article according to any one of Embodiments 1-24, wherein each of the shaped abrasive composites independently has 3, 4, or 6 walls.

Embodiment 26 provides the structured abrasive article according to any one of Embodiments 1-25, wherein the shaped abrasive composite has 4 walls.

Embodiment 27 provides the structured abrasive article according to any one of Embodiments 5-26, wherein the cross-sectional shape of the first end of the contoured base is substantially square.

Embodiment 28 provides the structured abrasive article according to any one of Embodiments 1-27, wherein the shaped abrasive composites are free of contact with one another.

Embodiment 29 provides the structured abrasive article according to any one of Embodiments 1-28, wherein the shaped abrasive composites are separated by a plurality of contoured channels extending across the first major surface of the backing.

Embodiment 30 provides the structured abrasive article according to any one of Embodiments 1-29, wherein the shaped abrasive composites collectively comprise a close-packed array.

Embodiment 31 provides the structured abrasive article according to any one of Embodiments 1-30, wherein at least some of the facets contacting adjacent cusps independently define a second dihedral angle ranging from about 120 to about 135 degrees.

Embodiment 32 provides the structured abrasive article according to any one of Embodiments 1-31, wherein each of the shaped abrasive composites has substantially a same size and shape.

Embodiment 33 provides the structured abrasive article according to any one of Embodiments 1-32, further comprising a supersize disposed on the abrasive layer.

Embodiment 34 provides the structured abrasive article according to any one of Embodiments 1-33, wherein:

the sidewalls of the contoured base have a height of about 30 mils to about 60 mils and the walls have a height of from about 40 mils to about 100 mils;

facets contacting adjacent cusps independently define a dihedral angle of about 120 to about 135 degrees;

the walls independently form a respective dihedral angle with the contoured base of about 78 to about 90 degrees;

the shaped abrasive composites are separated by a plurality of channels extending across the first major surface of the backing, wherein the channels have a width in a range of about 10 to about 80 mils; and

the shaped abrasive composite has a height, wherein the recessed feature has a lowest point that has a height in a range of from about 40 to about 80 percent of the height of the shaped abrasive composite.

Embodiment 35 provides the structured abrasive article according to Embodiment 34, wherein the channels independently have a curved profile formed from adjacent contoured bases.

Embodiment 36 provides the structured abrasive article according to any one of Embodiments 34 or 35, wherein the sidewalls are curved to form a fillet.

Embodiment 37 provides the structured abrasive article according to any one of Embodiments 34-36, wherein the channels independently have a tapered profile formed from adjacent contoured bases.

Embodiment 38 provides a method of abrading a workpiece, the method comprising:

contacting at least a portion of the abrasive layer of the structured abrasive article according to any one of Embodiments 1-37 with a surface of the workpiece; and

moving at least one of the workpiece or the abrasive layer relative to the other to abrade at least a portion of the surface of the workpiece.

Embodiment 39 provides a method of forming the structured abrasive article according to any one of Embodiments 1-38, the method comprising:

disposing the shaped abrasive composites on the backing.

Embodiment 40 provides the method of according to Embodiment 39, and further comprising:

forming the shaped abrasive composites.

Embodiment 41 provides the method according to any one of Embodiments 39 or 40, wherein forming the shaped abrasive composites comprises:

contacting the abrasive particles and the polymeric binder with a mold.

Embodiment 42 provides the method according to Embodiment 41, wherein the mold comprises a profile that is a negative impression of the shaped abrasive composite formed therein.

1. A structured abrasive article comprising:
a backing having first and second opposed major surfaces; and
an abrasive layer disposed on and secured to the first major surface, wherein the abrasive layer comprises shaped abrasive composites, wherein each of the shaped abrasive composites comprises abrasive particles dispersed in a polymeric binder, and wherein each of the shaped abrasive composites independently comprises:
a contoured base comprising:
a first end disposed on the backing;
a second end; and
a plurality of sidewalls connecting the first end and the second end;
a plurality of walls extending away from the second end of the contoured base, wherein adjacent walls share a common edge, wherein each wall forms a first dihedral angle with the second end of the contoured base of less than or equal to 90 degrees; and
a grinding surface free of contact with the contoured base, wherein the grinding surface comprises:
a plurality of cusps; and
a plurality of facets that contact a recessed feature containable within a geometric plane, wherein at least a portion of the recessed feature is disposed closer to the contoured base than is each of the cusps, and wherein each cusp is formed by an intersection of three or more surfaces comprising the walls, the facets, or a combiantion thereof, wherein at least one of the surfaces is a facet.

2. The structured abrasive article of claim 1, wherein a cross-sectional area of the first end of the contoured base is larger than a cross-sectional area of the second end of the contoured base.

3. The structured abrasive article of claim 2, wherein the cross-sectional area of the first end is about 1.25 times to about 5 times larger than the cross-sectional area of the second end.

4-19. (canceled)

20. The structured abrasive article of claim 1, wherein each of the cusps is substantially equidistant from the second end of the contoured base.

21. The structured abrasive article of claim 1, wherein the recessed feature is a polygon.

22. The structured abrasive article of claim 1, wherein the recessed feature is a line.

23. The structured abrasive article of claim 1, wherein the recessed feature is a point.

24. The structured abrasive article of claim 1, wherein the recessed feature has a lowest point that is higher than half of a height of the shaped abrasive composite.

25. The structured abrasive article of claim 1, wherein each of the shaped abrasive composites independently has 3, 4, or 6 walls.

26. (canceled)

27. The structured abrasive article of claim wherein the contoured base has a constant cross-sectional shape between the first end and the second end, and wherein the cross-sectional shape of the first end of the contoured base is substantially square.

28. The structured abrasive article of claim 1, wherein the shaped abrasive composites are free of contact with one another.

29. The structured abrasive article of claim 1, wherein the shaped abrasive composites are separated by a plurality of contoured channels extending across the first major surface of the backing.

30. (canceled)

31. The structured abrasive article of claim 1, wherein at least some of the facets contacting adjacent cusps independently define a second dihedral angle ranging from about 120 to about 135 degrees.

32-33. (canceled)

34. The structured abrasive article of claim 1, wherein:
the sidewalls of the contoured base have a height of about 30 mils to about 60 mils and the walls have a height of from about 40 mils to about 100 mils;
facets contacting adjacent cusps independently define a dihedral angle of about 120 to about 135 degrees;
the walls independently form a respective dihedral angle with the contoured base of about 78 to about 90 degrees;
the shaped abrasive composites are separated by a plurality of channels extending across the first major surface of the backing, wherein the channels have a width in a range of about 10 to about 80 mils; and
the shaped abrasive composite has a height, wherein the recessed feature has a lowest point that has a height in a range of from about 40 to about 80 percent of the height of the shaped abrasive composite.

35. The structured abrasive article of claim 34, wherein the channels independently have a curved profile formed from adjacent contoured bases.

36. The structured abrasive article of claim 35, wherein the sidewalls are curved to form a fillet.

37. The structured abrasive article of claim 34, wherein the channels independently have a tapered profile formed from adjacent contoured bases.

38. A method of abrading a workpiece, the method comprising:
contacting at least a portion of the abrasive layer of the structured abrasive article of claim 1 with a surface of the workpiece; and
moving at least one of the workpiece or the abrasive layer relative to the other to abrade at least a portion of the surface of the workpiece.

39. A method of forming the structured abrasive article of claim 1, the method comprising:
disposing the shaped abrasive composites on the backing.

40. The method of claim 39, and further comprising:
forming the shaped abrasive composites.

41. The method of claim 40, wherein forming the shaped abrasive composites comprises:
contacting the abrasive particles and the polymeric binder with a mold.

42. The method of claim 41, wherein the mold comprises a profile that is a negative impression of the shaped abrasive composite formed therein.
